(19) United States
(12) Patent Application Publication
(10) Pub. No.: US 2014/0214897 A1
(43) Pub. Date: Jul. 31, 2014

(54) SYSTEMS AND METHODS FOR ACCESSING A NoSQL DATABASE USING BUSINESS INTELLIGENCE TOOLS

(71) Applicants: Yuankai Zhu, Paris (FR); Mohamed Badreddine Aouad, Asniers-Sur-Seine (FR); Steffen Lutter, Levallois (FR)

(72) Inventors: Yuankai Zhu, Paris (FR); Mohamed Badreddine Aouad, Asniers-Sur-Seine (FR); Steffen Lutter, Levallois (FR)

(21) Appl. No.: 13/755,203

(22) Filed: Jan. 31, 2013

(51) Int. Cl. G06F 17/30

(52) U.S. Cl. CPC G06F 17/30864
USPC 707/771

(57) ABSTRACT

A method for querying an NoSQL provider includes a server receiving a relational database query from an application running on a client computer that is coupled to the server via an electronic communication network, parsing the relational database query, creating an execution plan based on the results of the parsing step, transmitting a NoSQL query to the NoSQL provider, the NoSQL query including at least a portion of the execution plan, transforming at the server a response from the NoSQL provider into a relational format, and providing the transformed response to the client computer application. A system for implementing the method and a non-transitory computer readable medium are also disclosed.

### BACKGROUND

There is a vast amount of data available today, and data is now being collected and stored at a rate never seen before. More and more data is stored and processed in the cloud (i.e., hardware and software services available via the Internet). A portion of the data stored in the cloud can be stored in NoSQL database management systems (DBMS) (e.g., DBMS that do not adhere to relational DBMS models, do not use structured query language (SQL) for data handling, and are schema-less).

One example of a NoSQL DBMS is DynamoDB (trademark pending), a commercial product offered by Amazon Technologies, Inc. of Reno, Nev. As DynamoDB is a NoSQL database, there is only little metadata like concrete sets of columns with their data types. The NoSQL data model can include a table that can be a collection of data items (as opposed to a relational database where the table is a collection of rows). The NoSQL data model is schema-less in that each of the data items in a NoSQL database table can have different attributes, and even a different number of attributes. Some implementations of NoSQL tables have a primary key that can be a single attribute, or a combination of attributes. For these implementations, the primary key attribute must exist for each item within the table. Under these implementations the NoSQL data item attributes associated with a data item can have an attribute name and a value, or set of values.

### BRIEF DESCRIPTION OF THE DRAWINGS

FIG. 1 depicts a system in accordance with some embodiments;

FIG. 2 depicts a process in accordance with some embodiments; and

FIG. 3 depicts flow diagram 300 in accordance with an embodiment of FIG. 2.

### DETAILED DESCRIPTION

A system and method according to an embodiment can provide SQL-based business intelligence tools, applications, and/or platforms access to data stored in a NoSQL database system. Thus, the vast amount of data being stored in NoSQL databases in the cloud can be analyzed and reports generated based on this data using Business Intelligence solutions.

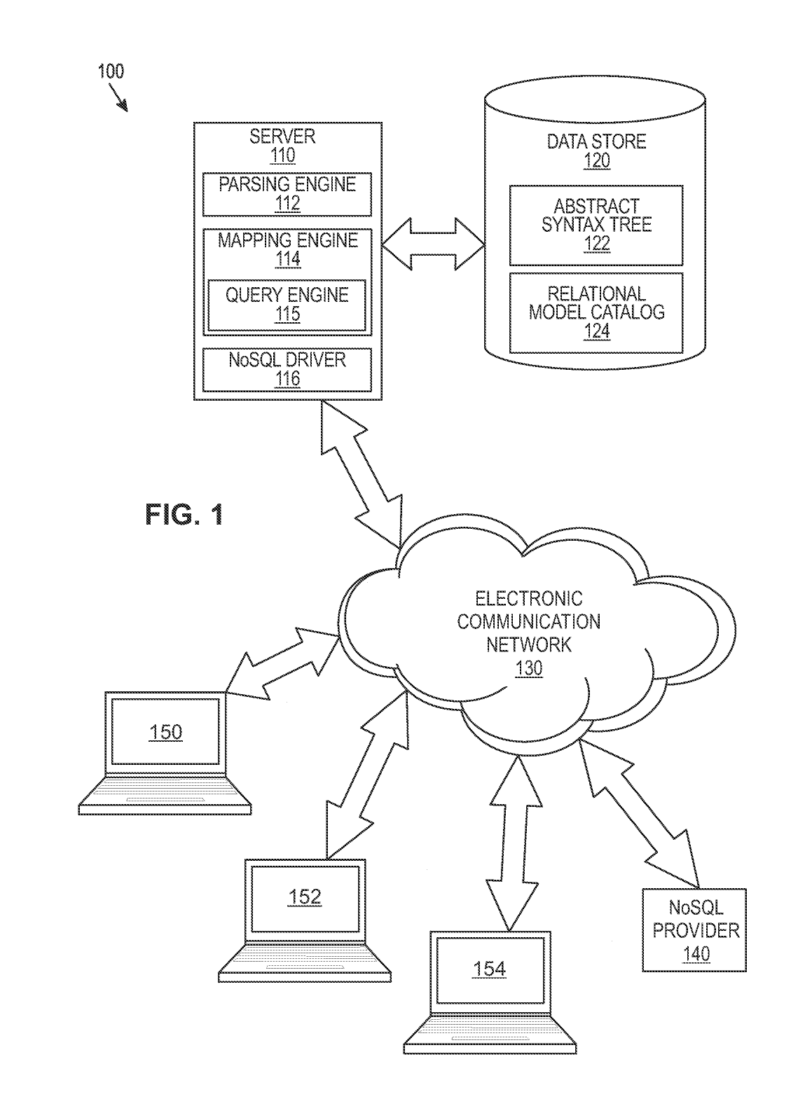

FIG. 1 depicts system 100 in accordance with one or more embodiments. System 100 can include server 110 that can include at least one central controller. The central controller may be a processing unit, a field programmable gate array, discrete analog circuitry, digital circuitry, an application specific integrated circuit, a digital signal processor, a reduced instruction set computer processor, etc. Server 110 may include internal memory (e.g., volatile and/or non-volatile memory devices) coupled to the central controller. The central controller may access a computer application program stored in non-volatile internal memory, or stored in an external memory that can be connected to the central controller via an input/output (I/O) port. The computer program application may include code or executable instructions that when executed may instruct or cause the central controller and other components of the server to perform embodying methods, such as a method of providing responses to a relational database model query by accessing data from a NoSQL provider.

Server 110 can include parsing engine module 112, mapping engine 114, and NoSQL driver module 116 that are coupled to the central controller. The parsing engine, mapping engine, and NoSQL driver can be dedicated hardware, software, and/or firmware modules.

Server 110 can be in communication with data store 120. In some embodiments, Data store 120 can be part of an object-relational database management system, a relational database management system, or any other database management system. In some embodiments, data store 120 can be implemented in Random Access Memory (e.g., cache memory for storing recently-used data) and/or one or more fixed disks (e.g., persistent memory for storing the full database). Alternatively, data store 120 can implement an “in-memory” database, in which volatile (e.g., non-disk-based) memory (e.g., RAM)) can be used both for cache memory and for storing the full database. In some embodiments, the data of data store 120 can comprise one or more of row-based data stored in row format, column-based data stored in columnar format, and object-based data. Data store 120 can also or alternatively support multi-tenancy by providing multiple logical database systems which are programmatically isolated from one another. Moreover, the data of data store 120 can be indexed and/or selectively replicated in an index to allow fast searching and retrieval thereof

Data store 120 can be a repository for one or more instantiations of abstract syntax tree 122 and relational model catalog 124 sent to the data store by NoSQL driver module 116. The relational model catalog can be used to examine the mapped schema of the NoSQL database so as to answer metadata queries from business intelligence tools. Communication between the server (e.g., NoSQL driver module 116) and data store 120 can be either over electronic communication network 130, or a dedicated communication path. In another embodiment, NoSQL driver 116 can store abstract syntax tree 122 and relational model catalog 124 in memory internal to the server.

Electronic communication network 130 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 130.

Connected to server 110 via electronic communication network 130 are one or more client computer(s) 150, 152, 154. The client computers can be any type of computing device suitable for use by an end user (e.g., a personal computer, a workstation, a thin client, a netbook, a notebook, tablet computer, etc.). The client computer can be coupled to a disk drive (internal and/or external). The client computers can include a business intelligence tool application or any application that can pull data using relational database queries (e.g., data migration tools, management tools that can present data in graphic form (tabular, charts, etc.), and the like). In some implementations the business intelligence tool application can be located at the server. The business intelligence tool application can, for example, be based on a relational database model, such as a table that is organized into rows and columns and/or into columnar form.

A business intelligence tool can utilize graphs, charts, and conditional highlighting; drill down into, and across, reports; sort, filter, and format data; model scenarios visually; provide pre-integrated, pretested solutions; provide a combined resource planning and solution to consolidate data. Queries can include, for example, (i) projection; (ii) filtering; (iii) ordering; (iv) grouping; (v) an aggregate function; (vi) a nested query; and/or (vii) joining sales data, purchase order data, and/or information about employees from one or more data sources in the form of a table or report. The user might direct a query to, and receive data from, various data sources (either coupled locally to the client computer or via electronic communication network 130). Embodying systems and methods parse, map, and/or transform the relational database request so that data from a NoSQL provider can be made accessible to the business intelligence tool.

Connected to the electronic communication network can be NoSQL provider 140. NoSQL provider 140 can be coupled to a NoSQL data source. Data within the NoSQL data source can be organized in a schema-less manner that does not adhere to relational DBMS models. For example, the NoSQL data source can include one or more tables, where each table is a collection of data items having different attributes but with a primary key attribute common to each data item. Data within the NoSQL data source can be requested, for example, by accessing an application program interface (API) using a JSON (JavaScript Object Notation) request. Other protocols than JSON can be implemented by the NoSQL system, and embodying systems and methods can be adapted for those implementations.

However, the systems and methods presented herein operate independent of the particular specifics regarding the configuration of the NoSQL provider and/or the NoSQL source. For purposes of this disclosure, the NoSQL provider and NoSQL data source can be viewed as “black boxes” that receive queries and provide responses as described below.

By way of example, server 110 can be implemented as ConnectionServer, a component used by SAP Business Objects Enterprise (BOE) products (SAP, Walldorf, Germany) to connect to various data sources. Server 110 further can include NoSQL driver module 116 that is configured to provide support for relational database query operations that may not be defined by the particular developer of NoSQL provider 140. The NoSQL driver module can be used to perform relational database query operations that were not included by the application developer for the one or more applications resident on a NoSQL provider. Accordingly, server 110 and NoSQL driver module 116 permit connection to one or more NoSQL providers so that business intelligence reporting can access data from NoSQL data sources.

Embodying methods and systems allow a seamless integration with Business Intelligence (BI) products by representing NoSQL data source tables and fields as relational database objects. These database objects can then be queried using SQL. Mapping engine 114 can map a relational database query (e.g., SQL statements) to corresponding NoSQL API requests with operations the provider can process, while other operations are processed by NoSQL driver 116 of server 110.

Server 110 can establish a connection to a NoSQL data source endpoint via electronic communication network 130. From the endpoint, basic information to build a basic internal metadata model can be downloaded to server 110. If table metadata is requested, a detection algorithm can scan the data to build up the mapping based on the data by implementing data sampling. Alternately, the schema can be mapped from a schema description file provided by a user. In accordance with some embodiments, performance optimization can be accomplished by internally caching the metadata to minimize network traffic and avoid performance loss across multiple queries. The BI tool can query metadata and data as any other data source.

In accordance with at least one embodiment, data can be requested by using uniform resource identifiers (URI) and implementing representational state transfer (REST) principles. Other embodiments can implement other approaches and protocols to request data. According to some embodiments, NoSQL data collections can be represented as relational database objects to permit integration to business intelligence tools (for example, BOE products).

A business intelligence tool can communicate with server 110 to obtain access to a NoSQL data provider via an application program interface (API). In accordance with an embodiment, the API used by the business intelligence tool can be the same API it might use to access other types of data sources, such as relational database management systems. Server 110 can establish a communication connection with NoSQL data provider 142 to download metadata document(s). The metadata documents can be used to build an internal metadata models. The metadata obtained from the NoSQL data provider might be limited to, for example, names of available data collections and/or datasets, and information regarding the primary keys (e.g., type and name). These metadata models may be located in internal memory of server 110, or an external memory connected to the server—for example data store 120. Embodying methods can adapt a NoSQL data model to appear as a relational model that is exposed by server 110 to the business intelligence tool. The business intelligence tool can query metadata and data from the NoSQL data source as it would any other data source.

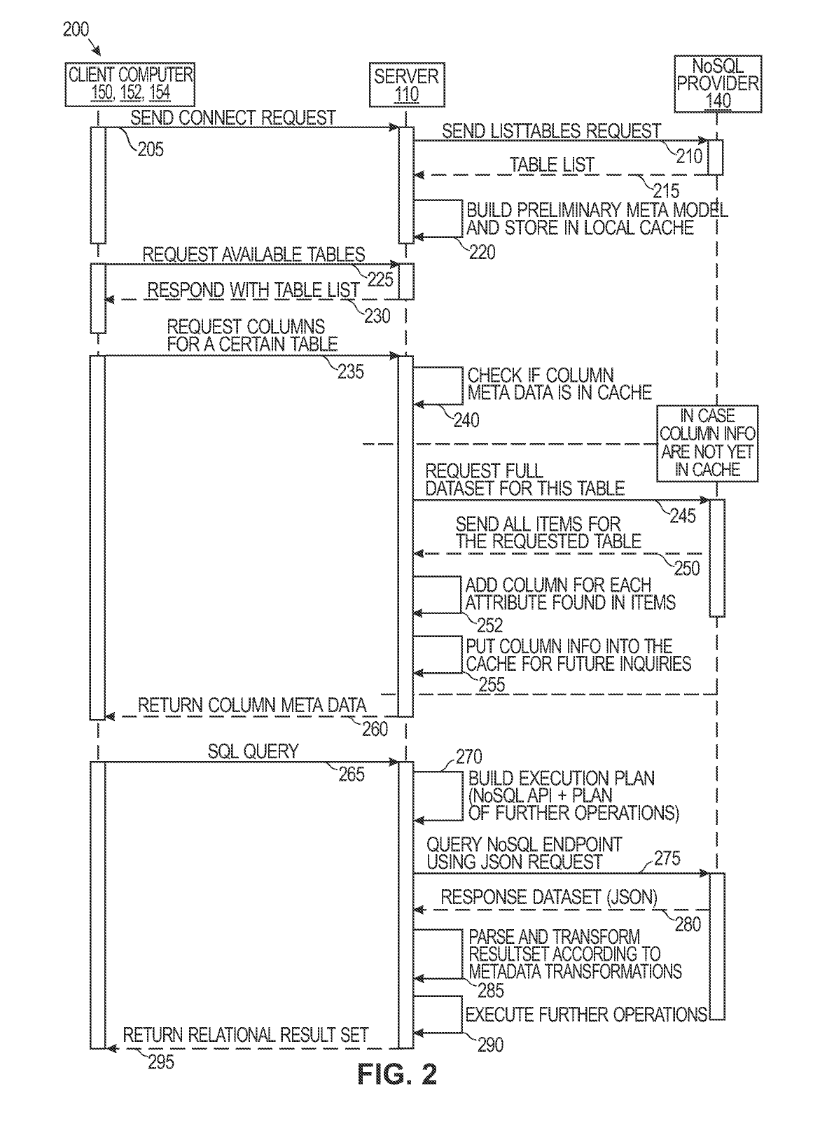

FIG. 2 depicts process 200 that can access a NoSQL provider to obtain a response to a relational database query request in accordance with some embodiments. The business intelligence tool on client computer 150, 152, 154 can send a connection request, step 205, to server 110. In some embodiments, server 110 can be a component that can be used as a library of the business intelligence tool. A driver operating on server 110 can request, step 210, for example, a table list of data collections and/or datasets from NoSQL provider 140. The NoSQL provider can return the requested table list containing data collections and/or datasets, step 215, to the server. The systems and methods presented herein operate independent of the particular specifics regarding the configuration(s) of the NoSQL provider and/or the NoSQL source. The server can download the table list and build an internal meta model, step 220, in local cache. The internal meta model can be stored, for example, in data store 120. The table list can be parsed by parsing engine 112 and mapped (e.g., transformed) by mapping engine 114.

In accordance with an embodiment, the business intelligence tool can make a request for tables available from the NoSQL provider, step 225, to the server. The server can map this request to the data in the internal meta model resident in cache to generate a table list response, step 230. The business intelligence tool can request, step 235, one or more columns for a table listed on the table list response.

In response to the column request, server 110 can check, step 240, if the internal meta model (step 220) contains the column metadata being requested. If the requested column data is resident in the internal meta model, process 200 continues to step 260, where the column metadata is returned to the business intelligence tool in response to the request made at step 225.

If the requested column data is not resident in the internal meta model, process 200 continues to step 245, where server 110 sends a request to the NoSQL provider to obtain a full dataset for the table referenced by the business intelligence tool request at step 235. In response to the server's request, NoSQL provider 140 can return additional and/or all items for the requested table, step 252. The server processes the returned items, step 255, to add a column for each attribute found in the returned items. This column of information is added to the table in the internal meta model, step 255. The column metadata can then be returned, step 260, to the business intelligence tool in response to the request made at step 225.

Further, in accordance with some embodiments, a relational database request (e.g., a SQL query) sent by the business intelligence tool, step 265, can be parsed and transformed to an abstract syntax tree that may be stored in data store 120. NoSQL driver 116 can create an execution plan, step 270. This execution plan can be based on the relational database request received at step 265. The execution plan can include NoSQL operations supported by the NoSQL provider's API, as well as further operations which might not be supported by, for example, the NoSQL provider's configuration.

The server can transmit a protocol query (e.g., JSON for the DynamoDB) to the NoSQL endpoint, step 275, containing supported operations to the NoSQL provider. A response dataset from the NoSQL provider to the server, step 280, can be a document, file, etc. and may, for example, by in XML or JSON format. This response can be parsed and transformed, step 285, to a relational format according to metadata transformations. Additional operations can be executed at the server by NoSQL driver 116, step 290. Depending on the particular operations supported by NoSQL provider 140, these additional operations could include, for example, data grouping, creation of datasets having distinct values, complex filter evaluation (e.g., pattern comparisons—‘name LIKE “A %”’ can return names starting with “A”). A relational result set can be returned to the business intelligence tool, step 295.

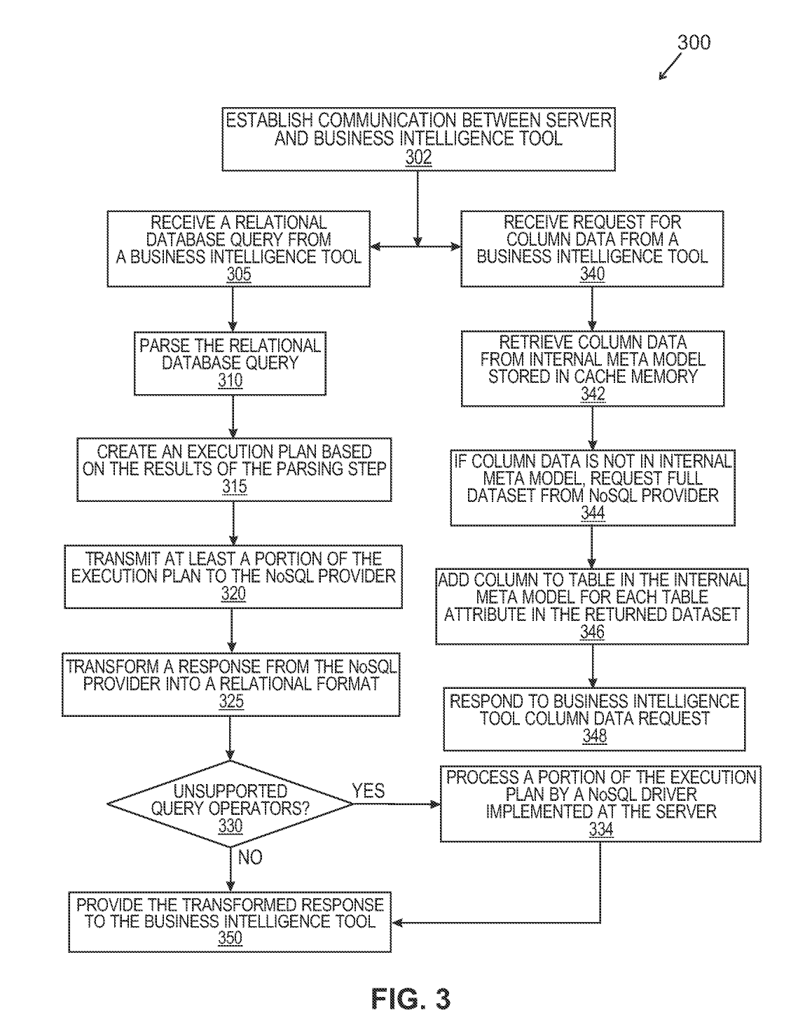

FIG. 3 depicts a flow diagram for process 300 in accordance with at least one embodiment depicted in FIG. 2. Process 300 can begin by establishing communication between server 110 and a business intelligence tool that can be located in client computer 150, 152, 154, step 302. In some implementations the business intelligence tool application can be located at the server. If server 110 receives a relational database query from a business intelligence tool, process 300 can continue at step 305. If server 110 receives from a business intelligence tool a request for columns from a particular table, process 300 can continue at step 340 (described below).

The relational database query received at step 305 can be parsed, step 310, using parsing engine module 112. An execution plan can be created, step 315, by NoSQL driver 116 based on the results of step 310. The execution plan can contain both NoSQL operations supported by an API at NoSQL provider 140, and non-supported NoSQL operations. At least a portion of the execution plan containing supported operations can be sent to the NoSQL provider for processing, step 320. A response from the NoSQL data source can be transformed, step 325, into a relational format. The transformation of the response can be performed by mapping engine 114 according to metadata transformations.

If the relational database query contained operators not supported by the NoSQL provider, step 330, process 300 can continue at step 334. If there were no unsupported query operators, process 300 can continue at step 350.

The portion of the execution plan containing non-supported operations can be processed at server 110 by NoSQL driver 116, step 334. In one implementation, NoSQL driver 116 may also process at least a portion of the supported operations.

The response(s) from steps 325 and 334 can be provided to the business intelligence tool at step 350.

In accordance with some embodiments, if server 110 receives a request for column data from a business intelligence tool, step 340, process 300 can include retrieving column data for a particular table from an internal meta model stored in cache memory (e.g., stored in data store 120 or in the server internal memory), step 342. If the internal meta model does not contain the requested column data for a particular table, server 110 can request a full dataset for the table from the NoSQL provider, step 344. At step 346, the server can add a column, step 346, to the table in the internal meta model for each table attribute contained in the dataset returned from the NoSQL provider. The server returns the requested column data to the business intelligence tool, step 348.

A NoSQL provider can expose data in a NoSQL source, which can be transformed into relational model formatted data and exposed by an API in server 110, as described above. Mapping and/or transforming between these data formats are described below.

A NoSQL database, for example Amazon's DynamoDB, can be a schema-less database that is a collection of tables, where the table is a collection of items and each item is a collection of attribute-value pairs. DynamoDB supports multi-valued data. The attribute type can be String or Number. An item can contain several attribute-value pairs of which the attributes have the same attribute name but a different value (for the same attribute name, the value must be different). For example:

```
Items: [
{
    ID={S: person, },
    address={ SS: [Paris, Shanghai], } },
    name ={S: Yuankai },
    Number={N: 00, },
},
{
    ID={S: police, },
    Number={S: 911, },
}
]
```

An item with hash primary id “person” has attribute name “address” with value “Paris” and attribute name “address” with value “Shanghai” and attribute name “name” with value “Yuankai” and attribute name “Number” with value “00”. Another item with hash primary key “police” has only attribute name “Number” (here the type is String) with value “911”. The list of attributes for all items unless a full scan of the dataset is executed. In DynamoDB, when an administrator creates a table, the table primary key type could be defined as hash type primary key or as hash range type primary key. The former is a single key, and the latter is a pair of two keys.

Tables in a NoSQL database can be mapped into tables of the internal meta model described above. The following embodying implementations are described with regard to the DynamoDB NoSQL database. Other embodying implementations could differ for other NoSQL databases. The DynamoDB has two types of primary keys: (1) Hash Type Primary Key; and (2) Hash Range Type Primary Key. Either of these two types of primary keys can be mapped into primary keys of the internal meta model. DynamoDB has no foreign keys, so there for that particular NoSQL database there is no mapping of the foreign keys. However, in some implementations foreign keys of the NoSQL data source can be mapped into foreign keys of the internal meta model.

Mapping engine 114 can map attributes to the columns of the table(s) modeled in the server's internal meta model. In accordance with the convention implemented by a NoSQL data source, e.g., DynamoDB, the server can consider that one or all of the columns are nullable.

When building the internal meta model, server 110 can obtain column metadata from the table list returned by the NoSQL provider. In one implementation the server can perform a data sampling approach. In another implementation to obtain a column count, the server can read a SQLDDL (Data Definition Language) file.

In the data sampling mode, the NoSQL driver in server 110 can obtain the column metadata by either scanning the entire database information from the NoSQL provider, or scanning the number of lines given by the user. Scanning the entire database is a more accurate and complete approach. When scanning the number of lines provided by the user it is possible that the number of columns is incorrect, so if additional columns are revealed in the column metadata the user can decide to ignore them or indicate that an exception is acceptable. For example, the following is an exemplary data sampling approach:

```
Items: [
{
    ID={S: person, },
    address={ SS: [Paris, Shanghai], } },
    name ={S: Yuankai, },
    Number={N: 00, },
},
{
    ID={S: police, },
    address={ SS: Paris, },
    number={N: 911, },
}
]
```

Scanning only the first row provides the attributes list: ID,address,name,Number. In the above example, this can result in a problem when reading the second row, as the metadata is different. Performing a full scan can yield the attribute list: ID,address,name,Number,number. Note that “number” is parsed different from “Number” because case sensitivity is recognized. In accordance with some embodiments, a scan of a table portion can be implemented by a “quick scan” choice.

In the SQLDDL (SQL data definition language) file mode, the NoSQL driver in server 110 can read the SQLDDL file which gives the specification of the data source. For example, a SQLDDL file can reveal:

CREATE TABLE employees (

id DECIMAL PRIMARY KEY,
address VARCHAR(50) NULL,
name VARCHAR(50) NULL,
Number DECIMAL NULL,
number DECIMAL NULL,

);

DynamoDB does not synchronize read and write operations. If data is modified after server 110 reads the metadata, the server will return an exception for any unmatched data. In some embodiments, this multi-valued data set problem can be solved by transforming from Set to String. In the above example, the Number S and String Set can be transformed into String. Should any column contain a multi-value, the type of the column is made String. To change the Set to String, a delimiter is used. An exemplary delimiter convention could be “data_item1”,“data_item2” where data_item1 and data_item2 are values revealed by the SQLDDL file (e.g., Paris and Shanghai can be delimited to be the String: “Paris”,“Shanghai”). By way of further example, should the value include Paris, France and Shanghai, the delimited String would be “Paris, France”,“Shanghai”. However, should the value include a quotation mark (e.g., “or”), the quotation mark can be replaced with a slash (e.g., Paris”France and Shanghai can be delimited to “Paris\France”,“Shanghai”; should the value include a slash, then the delimiter can include double slashes, etc.

After obtaining the column metadata and performing the data sampling or SQLDDL file read operations, the resulting item can be mapped into rows (records) in the server's internal meta model by mapping engine 114.

SQL statements/operators perform operations on the data within a database—e.g., Projection, Filtering, Sort, etc. As described above, some of these operations can be mapped, parsed, and/or transformed and sent to the NoSQL provider for execution. Other operations that are not supported at the NoSQL provider side can be executed by NoSQL driver 116. In support of the NoSQL driver execution, query engine 115 can perform operations to transform, map, and/or parse the SQL and NoSQL operators to create queries and translate results. In some embodiments, the query engine can be supported in these operations by parsing engine 112 and mapping engine 114.

Tables I-IV represent implementation with regard to DynamoDB, for other NoSQL databases features can be added, changed, and/or deleted. Table I provides a correspondence between SQL operations/commands and counterpart NoSQL operations that are supported, for example, by DynamoDB. Unsupported operations are performed at Server 110 (by the NoSQL driver, or in conjunction with the mapping and/or parsing engines).

TABLE I

| SQL | | | Execution |
|---|---|---|---|
| Operation | SQL-99 | DynamoDB | Location |
| Projection | SELECT | AttributesToGet | Server 110 and |
| | <attribute_list> | | DynamoDB's API |
| Filter | WHERE <bool | ScanFilter | Server 110 and |
| | expression> | | DynamoDB's API |
| Rename | AS | No support | Server 110 |
| Sort | ORDER BY | No support | Server 110 |
| | <attribute_list> | | |
| | [ASC DESC] | | |
| Distinct | DISTINCT | No support | Server 110 |
| Join | JOIN | No support | No support |
| Grouping | GROUP BY | No support | Server 110 |
| Union, | UNION, | No support | Server 110 |
| Union All | UNION ALL | | |

For the DynamoDB, Amazon applies a pre-filter “Provider Projection” to reduce the size of the return from the Amazon server(s) to reduce bandwidth demand.

Filter expressions from DynamoDB use a JSON message format. In order to specify the filter in the request, a list of conditions is provided. For example:

“ScanFilter”:{
“AttributeName1”:{“AttributeValueList”:[{“S”:“AttributeValue”}],
“Comparison Operator”:“EQ”}
“AttributeName2”:{“AttributeValueList”:[{“S”:“AttributeValue”}],
“Comparison Operator”:“NE”}
},

Table II provides a correspondence between SQL comparison operators and NoSQL comparison operators supported by DynamoDB.

TABLE II

| | SQL 99 | DYNAMODB |
|---|---|---|
| Conjunction | AND | Sets of Condition |
| Disjunction | OR | No support |
| Negate | −x | No support |
| Not | NOT x | No support |
| Multiply | x * y | No support |
| Divide | x/y | No support |
| Addition | x + y | No support |
| Subtraction | x − y | No support |
| Modulo | x % y | No support |
| Less than | x < y | ComparisonOperator: “LT” |
| Greater than | x > y | ComparisonOperator: “GT” |
| Less than or equal | x <= y | ComparisonOperator: “LE” |
| Greater than or equal | x >= y | ComparisonOperator: “GE” |
| Equals | x = y | ComparisonOperator: “EQ” |
| Not equals | x != y | ComparisonOperator: “NE” |
| Existed | NOT | ComparisonOperator: “NOT_NULL” |
| | NULL | |
| No Existed | NULLs | ComparisonOperator: “NULL” |
| Checks for a substring | LIKE | ComparisonOperator: “CONTAINS” for String |
| Checks for absence of a substring | LIKE | ComparisonOperator: “NOT_CONTAINS” for String |
| Checks for a substring prefix | LIKE | ComparisonOperator: “BEGINS_WITH” |
| Checks for exact matches. | IN | ComparisonOperator: “IN” ¹ |
| Greater than, or equal to, the first | BETWEEN | ComparisonOperator: “BETWEEN” |
| value and less than, or equal to, | | |
| the second value | | |

¹ In attribute_list, operator IN only supports String or Number (not set). If the attribute to compare is a String Set with only one value [A], it is a no-match to the attribute_list String A.

Typically, a NoSQL data source, such as DynamoDB, can count result items, and does not support functions. In some implementations, the functions itemized in Table III can be performed by NoSQL driver 116.

TABLE III

| Function | SQL-99 | DynamoDB |
|---|---|---|
| Count | Count | Performed by NoSQL |
| | | driver |
| Average | Avg | Performed by NoSQL |
| | | driver |
| Minimum | Min | Performed by NoSQL |
| | | driver |
| Maximum | Max | Performed by NoSQL |
| | | driver |
| Sum | Sum | Performed by NoSQL |
| | | driver |

The NoSQL data source DynamoDB only supports the types Number and String (e.g., Number set and String set for multi-values). Numbers are positive or negative exact-value decimals and integers. A number can have up to thirty-eight digits of precision after the decimal point, and can be between 10⁻¹²⁸ to 10⁺¹²⁶. Table IV provides a correspondence between SQL types and JAVA types for both Number and String.

TABLE IV

| DynamoDB | SQL_Type | JAVA_Type |
|---|---|---|
| Number | SQL_Decimal | JAVA_BIGDECIMAL |
| String | SQL_VARCHAR | JAVA_String |

When connecting to one of the five Amazon endpoints (i.e., US EAST, US WEST, EU WEST, ASIA PACIFIC (Singapore), and ASIA PACIFIC (Tokyo)), a user provides both an accesskey and a secretkey. For the same user id, the US East server contains different tables than the US West server. After establishing a connection authorization to access data based on the user id, and keys is determined.

The configuration, protocol, bandwidth (e.g., NoSQL data source maximum data throughput), and other capabilities of the NoSQL provider can impact operation of NoSQL driver 116. Even so, NoSQL driver 116 can support various configuration parameters, but selection of certain parameters based on the NoSQL provider can change the behavior of the NoSQL driver.

Server 110 accepts SQL queries as input from a BI client. These SQL queries are mapped, transformed, and/or translated to an execution plan that involves querying, for example, NoSQL provider 140 and its associated NoSQL database. Functionality that is not supported by the NoSQL provider is compensated for by server 110.

Because NoSQL provider 140 can connect to a schema-less data source, server 110 can implement at least two techniques—automatic data sampling and metadata definition by schema files (i.e., SQLDDL). Data sampling provides caching to decrease network traffic and increase performance. The metadata definition approach returns an exception should any unmatched data be found.

Queries to the NoSQL provider are formatted specifically for the data source being queried—for example, DynamoDB is accessed through an API, so queries are designed for that API.

In accordance with an embodiment of the invention, a computer program application stored in non-volatile memory or computer-readable medium (e.g., register memory, processor cache, RAM, ROM, hard drive, flash memory, CD ROM, magnetic media, etc.) may include code or executable instructions that when executed may instruct or cause a controller or processor to perform methods discussed herein such as a method for mapping and/or transforming relational model queries to gain access to data stored in an NoSQL data source.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and data configurations have been described herein, note that any number of other configurations may be provided in accordance with embodiments of the invention. Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A computer-implemented method for querying an NoSQL provider in communication with a server via an electronic communication network, the method comprising:
receiving at the server a relational database query from an application running on a client computer coupled to the electronic communication network;
parsing by a parsing engine the relational database query;
creating an execution plan based on the results of the parsing step;
transmitting a NoSQL query to the NoSQL provider, the NoSQL query including at least a portion of the execution plan;
transforming at the server a response from the NoSQL provider into a relational format; and
providing the transformed response to the client computer application.

2. The method of claim 1, wherein the parsing step further includes creating an abstract syntax tree based on objects of the relational database query.

3. The method of claim 1, wherein the execution plan contains NoSQL supported operations that correspond to operations included in the relational database query.

4. The method of claim 1, further including mapping the relational database query to one or more NoSQL application program interface requests.

5. The method of claim 1, further including:
processing at least a portion of the execution plan by an NoSQL driver implemented at the server;
transforming at least one result of the processing step into a relational format; and
providing the transformed at least one result to the client computer application.

6. The method of claim 5, wherein the NoSQL driver processes portions of the execution plan containing operations unsupported at the NoSQL provider.

7. The method of claim 5, wherein the at least one result is in a relational format.

8. The method of claim 5, wherein the processing step includes accessing content of at least one relational model catalog, wherein the content of the at least one relational model catalog has a correspondence with content received from the NoSQL provider.

9. The method of claim 1, further including:
retrieving, at the server, table list metadata from the NoSQL provider;
building in server local cache an internal meta model of the table list metadata; and
responding to a client computer application metadata request based on the internal meta model.

10. The method of claim 9, further including:
mapping a request for tables available from the NoSQL provider to the data in the internal meta model; and
generating a table list response.

11. A non-transitory computer readable medium having stored thereon instructions which when executed by a processor cause the processor to perform the method of:
receiving a relational database query from an application;
parsing the relational database query;
creating an execution plan based on the results of the parsing step;
transmitting a NoSQL query to a NoSQL provider, the NoSQL query including at least a portion of the execution plan;
transforming a response from the NoSQL provider into a relational format; and
providing the transformed response to the application.

12. The non-transitory computer readable medium of claim 11, further including executable instructions to cause a processor to control a NoSQL driver to perform the step of processing portions of the execution plan containing operations unsupported at the NoSQL provider.

13. The non-transitory computer readable medium of claim 11, further including executable instructions to cause a processor to perform the steps of:
processing at least a portion of the execution plan by an NoSQL driver;
transforming at least one result of the processing step into a relational format; and
providing the transformed at least one result to application.

14. The non-transitory computer readable medium of claim 13, further including executable instructions to cause a processor to perform the step of mapping the relational database query to one or more NoSQL application program interface requests.

15. The non-transitory computer readable medium of claim 11, further including executable instructions to cause a processor to perform the steps of:
retrieving table list metadata from the NoSQL provider;
building in local cache an internal meta model of the table list metadata; and
responding to an application metadata request based on the internal meta model.

16. The non-transitory computer readable medium of claim 15, further including executable instructions to cause a processor to perform the steps of:
mapping a request for tables available from the NoSQL provider to the data in the internal meta model; and
generating a table list response.

17. The non-transitory computer readable medium of claim 11, wherein the parsing step includes executable instructions to cause a processor to perform the step of creating an abstract syntax tree based on objects of the relational database query.

18. A system comprising:
a server connected to an electronic communication network, the server including a control processor, wherein a parsing engine, a mapping engine, and a NoSQL driver are coupled to the control processor;
the server being in communication with a data store over at least one of the electronic communication network and a dedicated communication path; and
the system is configured to transform a relational database query received by the server into an execution plan having at least one of a supported NoSQL operation and an unsupported NoSQL operation, and the NoSQL operation driver is configured to process the unsupported NoSQL operation at the server.

19. The system of claim 18, further including the system configured to map the relational database query to one or more corresponding NoSQL application program interface requests.

20. The system of claim 18, further including the system configured to access content of at least one relational model catalog, wherein the content of the at least one relational model catalog has a correspondence with content received from the NoSQL provider.
